(19) United States
(12) Patent Application Publication
(10) Pub. No.: US 2008/0165175 A1
(43) Pub. Date: Jul. 10, 2008

(54) Plasma display and driving method thereof

(76) Inventor: Yoo-Jin Song, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/987,541

(22) Filed: Nov. 30, 2007

(30) Foreign Application Priority Data
Jan. 9, 2007 (KR) 10-2007-0002446

(51) Int. Cl. G06F 3/038

(52) U.S. Cl. 345/212; 345/211

(57) ABSTRACT

A method of driving a plasma display that includes a plurality of first electrodes, a plurality of second electrodes, and a plurality of discharge cells corresponding to the first and second electrodes. The method includes performing an initial energy recovery circuit charging operation, and after performing the initial energy recovery circuit charging operation, performing a normal display operation. The normal display operation charges a first capacitive structure in an energy recovery circuit of the plasma display and discharges the first capacitive structure to the plurality of first electrodes, and the initial energy recovery circuit charging operation charges the first capacitive structure and does not discharge the first capacitive structure to the plurality of first electrodes.

### BACKGROUND OF THE INVENTION

1. Field of the Invention

Embodiments relate to a plasma display and a driving method thereof and, more particularly, to a plasma display and a driving method thereof in which an energy recovery circuit is charged using an initial charging operation.

2. Description of the Related Art

A plasma display is a flat panel display that uses plasma generated by a gas discharge process to display characters, images, etc. The plasma display may include a plurality of electrodes, e.g., scan, sustain and address electrodes, and discharge cells arranged in a matrix pattern and corresponding to the electrodes.

In driving the plasma display, a waveform alternately having a high-level voltage Vs, e.g., 5V, and a-low-level voltage, e.g., 0V, may be applied during a sustain period. In this case, a capacitance may exist on the panel due to a discharge space between scan and sustain electrodes. Because the discharge space operates as a capacitive load, an additional reactive power source, as well as a power source for the sustain discharge, may be required to apply the sustain discharge pulses of the high and low level voltages to the electrodes. Therefore, an energy recovery circuit may be provided for recovering and reusing the power from the reactive power source.

The energy recovery circuit may use a resonance of the electrode and an inductor by turning-on a transistor that connect the inductor to the electrodes, which may charge an energy recovery capacitor with a voltage Vs/2, where Vs/2 is an average of the high level voltage Vs and the low level voltage. More particularly, the energy recovery circuit may charge the energy recovery capacitor at the voltage Vs/2 using distribution resistors at an output terminal, where the output terminal outputs the voltage Vs. However, since the energy recovery capacitor is only initially charged at the voltage Vs/2 through the distribution resistors, a reactive power may be consumed on the normal driving thereof upon power-on of the plasma display. Further, providing the distribution resistors in the circuit may increase the cost of the circuit. Moreover, such a configuration may generate resistive heating.

In another design, the energy recovery circuit may apply the voltage Vs directly to the electrodes and may then use the energy stored at the electrodes to charge the energy recovery capacitor at the voltage Vs/2. However, in this case, when the voltage Vs is initially applied to the electrodes, a hard switching may occur at a transistor used to transmit the voltage Vs. Such a hard switching may increase power consumption and cause element damage, and also may cause electromagnetic interference (EMI).

The description of the related art provided above is not prior art, but is merely a general overview that is provided to enhance an understanding of the art, and does not necessarily correspond to a particular structure or device.

### SUMMARY OF THE INVENTION

Embodiments are therefore directed to a plasma display and a driving method thereof, which substantially overcome one or more of the problems due to the limitations and disadvantages of the related art.

It is therefore a feature of an embodiment to provide a plasma display and a driving method thereof in which an initial charging of an energy recovery circuit may be performed before normal operation of the display.

It is therefore another feature of an embodiment to provide a wall charge control period before the initial charging of the energy recovery circuit.

At least one of the above and other features and advantages may be realized by providing a method of driving a plasma display that includes a plurality of first electrodes, a plurality of second electrodes, and a plurality of discharge cells corresponding to the first and second electrodes. The method may include performing an initial energy recovery circuit charging operation, and after performing the initial energy recovery circuit charging operation, performing a normal display operation. The normal display operation may charge a first capacitive structure in an energy recovery circuit of the plasma display and discharges the first capacitive structure to the plurality of first electrodes, and the initial energy recovery circuit charging operation may charge the first capacitive structure and does not discharge the first capacitive structure to the plurality of first electrodes.

The initial energy recovery circuit charging operation may include, in sequence, applying a first voltage to the plurality of first electrodes, charging the first capacitive structure by connecting the plurality of first electrodes to a first capacitor via a first inductor, and applying a second voltage to the plurality of first electrodes, the second voltage being less than the first voltage.

The normal display operation may include, in sequence, discharging the first capacitive structure to the plurality of first electrodes by connecting the plurality of first electrodes to the first capacitor via the first inductor, applying the first voltage to the plurality of first electrodes, charging the first capacitive structure by connecting the plurality of first electrodes to the first capacitor via the first inductor, and applying the second voltage to the plurality of first electrodes.

The initial energy recovery circuit charging operation may further include applying the first voltage to the plurality of second electrodes, charging a second capacitive structure by connecting the plurality of second electrodes to a second capacitor via a second inductor, and applying the second voltage to the plurality of second electrodes. A waveform applied to the second electrodes may have a same shape as a waveform applied to the plurality of first electrodes and may be about 180 degrees offset from the waveform applied to the plurality of first electrodes.

The initial energy recovery circuit charging operation may include two or more cycles of the sequence of applying the first voltage to the plurality of first electrodes, charging the first capacitive structure, and applying the second voltage to the plurality of first electrodes.

The initial charging operation may be performed upon power-on of the display. The initial charging operation may be performed only upon power-on of the display.

The method may further include performing a wall charge controlling operation before performing the initial energy recovery circuit charging operation, the wall charge controlling operation including applying a first waveform to the plurality of first electrodes and applying a fourth waveform to the plurality of second electrodes, such that a discharge occurs in the discharge cells.

A second waveform may be applied to the plurality of first electrodes during the initial energy recovery circuit charging operation, a third waveform may be applied to the plurality of second electrodes during the initial energy recovery circuit charging operation, the third waveform may have a same shape as the second waveform and is about 180 degrees offset from the second waveform, and the third waveform and the fourth waveform may have different shapes.

Applying the first waveform to the plurality of first electrodes during the wall charge controlling operation may include applying a gradually increasing voltage to the plurality of first electrodes while a third voltage is applied to the plurality of second electrodes, the gradually increasing voltage increasing increased from a fourth voltage to a fifth voltage, and applying a gradually decreasing voltage to the plurality of first electrodes while a sixth voltage higher than the third voltage is applied to the plurality of second electrodes, the gradually decreasing voltage decreasing from a seventh voltage to an eighth voltage.

At least one of the above and other features and advantages may be realized by providing a plasma display, including a plurality of first electrodes, a plurality of second electrodes, a plurality of discharge cells corresponding to the first and second electrodes, and a scan electrode driving circuit configured to initially charge a first energy recovery circuit of the plasma display and, after initially charging the first energy recovery circuit, to normally drive the display. The scan electrode driving circuit may be configured to charge a first capacitive structure in the first energy recovery circuit and discharge the first capacitive structure to the plurality of first electrodes during the normal driving of the display, and the scan electrode driving circuit may be configured to charge the first capacitive structure and to not discharge the first capacitive structure to the plurality of first electrodes during the initial charging of the first energy recovery circuit.

The scan electrode driving circuit may be configured to sequentially apply a first voltage to the plurality of first electrodes, charge the first capacitive structure by connecting the plurality of first electrodes to a first capacitor via a first inductor, and apply a second voltage to the plurality of first electrodes, the second voltage being less than the first voltage, during the initial charging of the first energy recovery circuit.

The scan electrode driving circuit may be configured to sequentially discharge the first capacitive structure to the plurality of first electrodes by connecting the plurality of first electrodes to the first capacitor via the first inductor, apply the first voltage to the plurality of first electrodes, charge the first capacitive structure by connecting the plurality of first electrodes to the first capacitor via the first inductor, and apply the second voltage to the plurality of first electrodes during the normal driving of the display.

The plasma display may further include a sustain electrode driving circuit. The sustain electrode driving circuit may be configured to apply the first voltage to the plurality of second electrodes, charge a second capacitive structure in a second energy recovery circuit by connecting the plurality of second electrodes to a second capacitor via a second inductor, and apply the second voltage to the plurality of second electrodes during an initial charging of the second energy recovery circuit, and a waveform applied to the plurality of second electrodes may have a same shape as a waveform applied to the plurality of first electrodes and may be about 180 degrees offset from the waveform applied to the plurality of first electrodes.

The scan electrode driving circuit may be configured to apply the first voltage to the plurality of first electrodes, charge the first capacitive structure, and apply the second voltage to the plurality of first electrodes two or more times during the initial charging of the first energy recovery circuit.

The scan electrode driving circuit may be configured to initially charge the first energy recovery circuit upon power-on of the display. The scan electrode driving circuit may be configured to initially charge the first energy recovery circuit only upon power-on of the display.

The scan electrode driving circuit may be further configured to perform a wall charge controlling operation before the initial charging of the first energy recovery circuit, the wall charge controlling operation including applying a first waveform to the plurality of first electrodes and applying a fourth waveform to the plurality of second electrodes, such that a discharge occurs in the discharge cells.

The scan electrode driver may be configured to apply a second waveform to the plurality of first electrodes during the initial charging of the first energy recovery circuit, a sustain electrode driver may be configured to apply a third waveform to the plurality of second electrodes during an initial charging of a second energy recovery circuit, the sustain electrode driver may be configured to apply the fourth waveform to the plurality of second electrodes, the third waveform may have a same shape as the second waveform and may be about 180 degrees offset from the second waveform, and the third waveform and the fourth waveform may have different shapes.

Applying the first waveform to the plurality of first electrodes during the wall charge controlling operation may include applying a gradually increasing voltage to the plurality of first electrodes while a third voltage is applied to the plurality of second electrodes, the gradually increasing voltage increasing increased from a fourth voltage to a fifth voltage, and applying a gradually decreasing voltage to the plurality of first electrodes while a sixth voltage higher than the third voltage is applied to the plurality of second electrodes, the gradually decreasing voltage decreasing from a seventh voltage to an eighth voltage.

### BRIEF DESCRIPTION OF THE DRAWINGS

The above and other features and advantages will become more apparent to those of ordinary skill in the art by describing in detail example embodiments with reference to the attached drawings, in which:

FIG. 1 illustrates a schematic diagram of a plasma display according to an embodiment;

FIG. 2 illustrates a driving waveform of the plasma display according to an embodiment;

FIG. 3 illustrates a schematic diagram of a scan electrode driving circuit according to an embodiment;

FIG. 4 illustrates a timing diagram of a sustain driver of the scan electrode driving circuit of FIG. 3 during normal operation of the plasma display;

FIG. 5 illustrates a timing diagram of the sustain driver of the scan electrode driving circuit of FIG. 3 during an initial operation of the plasma display; and

FIG. 6 illustrates details of a charging period in the timing diagram of FIG. 5.

### DETAILED DESCRIPTION OF THE INVENTION

Korean Patent Application No. 10-2007-0002446, filed Jan. 9, 2007, in the Korean Intellectual Property Office, and entitled: “Plasma Display and Driving Method Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

Unless explicitly described to the contrary, terminology such as “an element coupled to another element” includes a state in which the two elements are directly coupled, as well as a state in which the two elements are coupled with one or more additional elements provided between them.

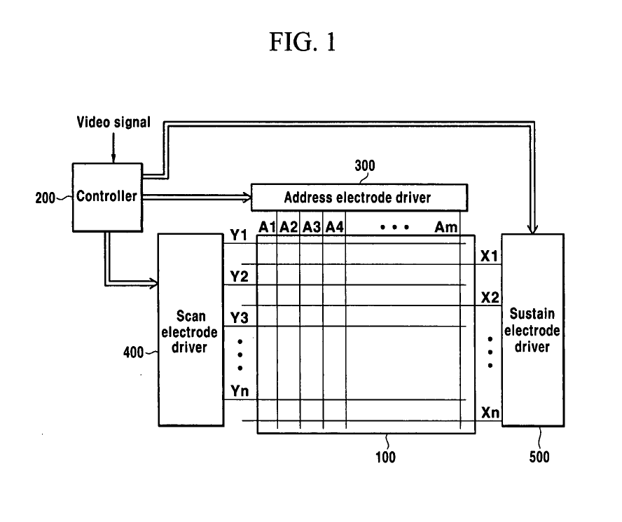

FIG. 1 illustrates a schematic diagram of a plasma display according to an embodiment.

As shown in FIG. 1, the plasma display may include a plasma display panel (PDP) 100, a controller 200, an address electrode driver 300, a scan electrode driver 400, and a sustain electrode driver 500.

The PDP 100 may include a plurality of address electrodes A1-Am (hereinafter referred to as “A electrodes”) extending in a column direction, and pluralities of scan electrodes Y1-Yn (hereinafter referred to as Y electrodes) and sustain electrodes X1-Xn (hereinafter referred to as X electrodes) extending in a row direction. The address electrodes A1-Am may perpendicularly cross the scan electrodes Y1-Yn and sustain electrodes X1-Xn. Individual sustain electrodes X may be paired with corresponding scan electrodes Y. The X and Y electrodes may perform a display operation for displaying images during a sustain period. Discharge spaces may be formed at regions where the address electrodes A1-Am cross the sustain and scan electrodes X1-Xn and Y1-Yn, and the discharge spaces may form discharge cells.

The controller 200 may receive an external video signal and may output A electrode driving control signals, X electrode driving control signals, and Y electrode driving control signals. The controller 200 may control the plasma display by dividing a frame or field into a plurality of subfields having respective brightness weight values. Each subfield may include a reset period, an address period, and a sustain period.

Upon receiving the address driving control signal from the controller 200, the address electrode driver 300 may apply display data signals, for selecting discharge cells to be displayed, to the respective address electrodes A1 to Am. The scan electrode driver 400 may apply a driving voltage to the Y electrodes upon receiving Y electrode driving control signals from the controller 200, and the sustain electrode driver 500 may apply a driving voltage to the X electrodes upon receiving X electrode driving control signals from the controller 200.

In operation, a frame or field, e.g., one TV field, may be divided into a plurality of respectively weighted subfields. Gray scales may be expressed by a combination of weights of the subfields. Each subfield may have an address period, in which an address operation for selecting discharge cells that are to emit light and discharge cells that are not to emit light is performed, and may have a sustain period corresponding to the weight of the subfield, in which a sustain discharge occurs in the discharge cells selected to emit light so as to perform a display operation.

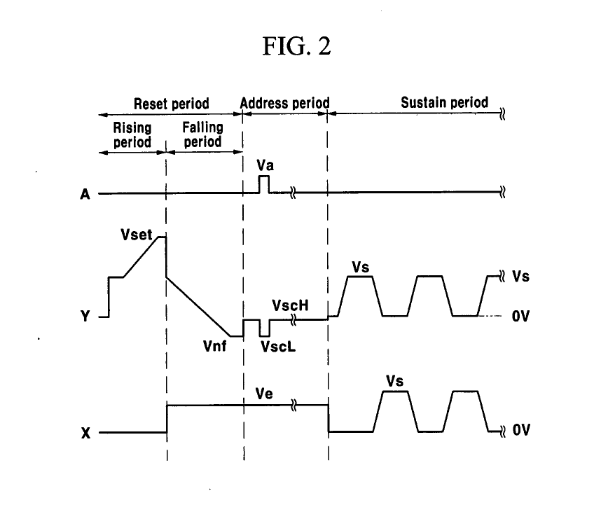

FIG. 2 illustrates a driving waveform of the plasma display according to an embodiment. For convenience of description, only part, i.e., a sustain period, of driving waveforms applied to the X, Y, and A electrodes for a single cell will be described.

During a rising period of a reset period in a first subfield, a rising waveform that gradually increases from a voltage Vs to a voltage Vset may be applied to the scan electrode Y while the sustain electrode X may be maintained at, e.g., 0V. The voltage of the Y electrode may be increased in a ramp pattern. Negative (−) wall charges may be formed on the Y electrode, and positive (+) wall charges may be formed on the X and A electrodes, and a weak discharge may be generated between the Y and X electrodes, and between the Y and A electrodes, while the voltage at the Y electrode is increased.

During a falling period of the reset period, a voltage Ve may be applied to the X electrode and the voltage at the Y electrode may be gradually decreased from the voltage Vs to a voltage Vnf. A weak discharge may be generated between the Y and X electrodes, and between the Y and A electrodes, while the voltage at the Y electrode is decreased. Thus, negative (−) wall charges formed on the Y electrode and positive (+) wall charges formed on the X and A electrodes may be eliminated.

A magnitude of a voltage difference Vnf−Ve may be set to be a discharge firing voltage between the Y and X electrodes. This may help reduce or prevent misfiring in a cell for which no address discharge was provided during the address period, since the wall voltage between the Y and X electrodes may be 0V.

In order to select a discharge cell that is to be turned-on during the address period, a scan pulse having a voltage VscL may be sequentially applied to the plurality of scan electrodes Y while a voltage of the X electrode is maintained at the voltage Ve. An address pulse may be applied to the A electrodes passing through the discharge cell to be selected, i.e., to be turned-on. An address discharge may be generated between the A electrode supplied with the voltage Va and the Y electrode supplied with the voltage VscL, and between the Y electrode supplied with the voltage VscL and the X electrode supplied with the voltage Ve. Thus, positive (+) wall charges may be formed on the Y electrode and negative (−) wall charges may be formed on the A and X electrodes. A voltage VscH, higher than the voltage VscL, may be applied to Y electrodes that are not supplied with the voltage VscL, and a reference voltage may be applied to the A electrodes that are not supplied with the voltage Va.

During the address period, the scan electrode driver 400 may select the Y electrode to be supplied with the scan pulse having the voltage VscL from among the Y electrodes Y1 to Yn. For example, scan electrode driver 400 may sequentially select the Y electrodes, with the sequence progressing in a vertical direction. When one of the Y electrodes is selected, the address electrode driver 300 may select a turn-on discharge cell from among the discharge cells corresponding to the selected Y electrode. That is, the address electrode driver 300 may select a cell to be supplied with the address pulse having the voltage Va.

For example, the scan pulse may be applied to a first row of the Y electrodes (Y1 of FIG. 1) and simultaneously the address pulse may be applied to the A electrodes corresponding to cells that are to be turned-on from among the first row. An address discharge may thus occur between the first row of the Y electrodes and the A electrodes supplied with the address pulse, positive (+) wall charges may be formed on the Y electrodes, and negative (−) wall charges may be formed on each of the A and X electrodes. Thus, a wall voltage Vwxy may be formed between the Y electrode and the X electrode, such that a potential of the Y electrode is higher than that of the X electrode. Subsequently, the scan pulse may be applied to a second row of the Y electrodes (Y2 of FIG. 1) and the address pulse may be applied to the A electrodes corresponding to cells that are to be turned-on from among the second row. Address discharge may occur between the second row of the Y electrodes and the A electrodes supplied with the address pulse, and wall charges may be formed in the selected cells. In similar fashion, the scan pulse may be sequentially applied to the remaining rows of the Y electrodes and the address pulse may be applied to the A electrodes of the corresponding cells to be turned-on.

During the sustain period, the sustain pulse, which may alternately have a high level voltage, i.e., the voltage Vs shown in FIG. 2, and a low level voltage, i.e., 0V as shown in FIG. 2, may be applied in to the Y electrode and the X electrode. The sustain pulse applied to the Y electrode may have a same shape as that applied to the X electrode while being offset, i.e., phase-shifted, therefrom. The offset may be, e.g., 180 degrees. For example, 0V may be applied to the X electrode while the voltage Vs is applied to the Y electrode, and 0V may be applied to the Y electrode while the voltage Vs is applied to the X electrode. This operation may be repeated a number of times corresponding to the weight value (gray scale value) of the subfield.

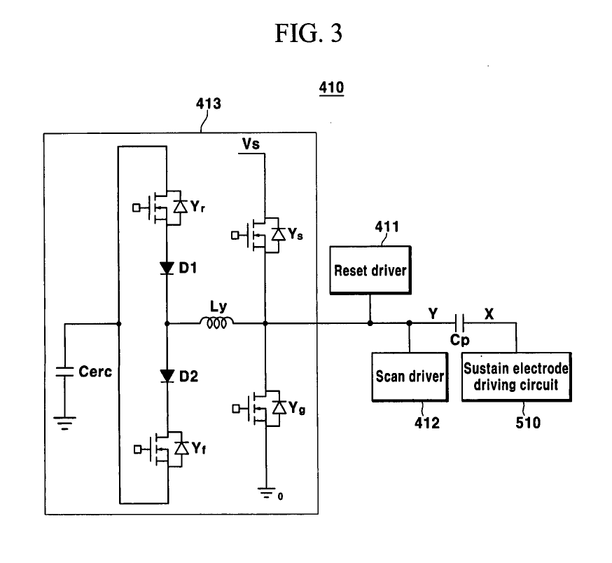

A scan electrode driving circuit 410 will now be described in detail with reference to FIG. 3, which illustrates a schematic diagram according to an embodiment.

Referring to FIG. 3, the scan electrode driving circuit 410 may be formed as part of the scan electrode driver 400. For ease of description, operations will be described with respect to a single X electrode and corresponding Y electrode, which may operate as capacitive component having a capacitance equivalent to a panel capacitor Cp.

As shown in FIG. 3, the scan electrode driving circuit 410 may include a reset driver 411, a scan driver 412, and a sustain driver 413.

The sustain driver 413 may include an inductor Ly, transistors Ys, Yg, Yr, and Yf, and diodes D1 and D2. In an implementation, the transistors Ys, Yr, Yf, and Yg may be n-channel field effect transistors such as n-channel metal oxide semiconductor (NMOS) transistors. The transistors Ys, Yr, Yf, and Yg may have a body diode formed from a source to a drain.

In other implementations (not shown) the transistors may be replaced with other transistors having similar functions and it will be appreciated that, while the transistors Ys, Yr, Yf, and Yg are individually provided in FIG. 3, the transistors Ys, Yr, Yf, and Yg may be formed by a plurality of transistors coupled in parallel.

Referring to the sustain driver 413, a drain of the transistor Ys may be coupled to a power source Vs, and a source of the transistor Ys may be coupled to the Y electrode and a drain of the transistor Yg. A source of the transistor Yg may be connected to a power source, e.g., a ground terminal, that supplies the low level voltage, e.g., 0V, and a drain of the transistor Yg may be connected to the Y electrode. A first terminal of the inductor Ly may be connected to the Y electrode, and a second terminal of the inductor Ly may be connected between a cathode of the diode D1 and an anode of the diode D2. A source of the transistor Yr may be connected to an anode of the diode D1 and a drain of the transistor Yf may be connected to a cathode of the diode D2. A drain of the transistor Yr and a source of the transistor Yf may be connected to the capacitor Cerc. The capacitor Cerc may serve as an energy storage and recovery element.

In operation, the capacitor Cerc may supply a voltage that is between the high level voltage Vs and the low level voltage, e.g., a voltage Vs/2 that is an average of the two voltages Vs and 0V. The diode D1 may provide a current path for increasing a voltage of the Y electrode, and the diode D2 may provide a current path for decreasing a voltage of the Y electrode.

In another implementation (not shown), if the transistors Yr and Yf have no body diode, the diodes D1 and D2 may be omitted. Further, the diode D1 may be disposed on the location of the transistor Yr and the transistor Yr may be disposed on the location of the diode D1, while the diode D2 may be disposed on the location of the transistor Yr and the transistor Yr may be disposed on the location of the diode D2.

The reset driver 411 may be connected to the Y electrode of the panel capacitor Cp and may supply a reset waveform to the plurality of Y electrodes during the reset period of each subfield. The scan driver 412 may supply the voltage VscL to the Y electrode of the turn-on cells, and may supply the voltage VscH to the Y electrode of the turn-on cells.

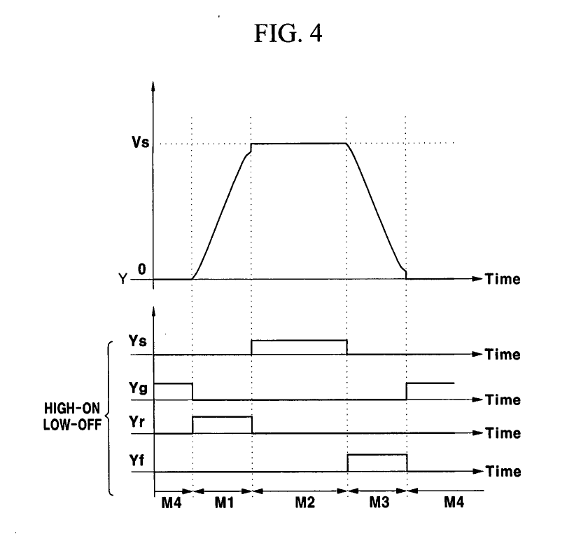

The operation of the sustain driver 413 shown in FIG. 3 will be described in greater detail with reference to FIG. 4, which illustrates a timing diagram of a sustain driver 413 of the scan electrode driving circuit 410 of FIG. 3 during normal operation of the plasma display.

Referring to FIG. 4, the transistor Yg may be turned on at a mode M4 just before a mode M1, such that 0V may be applied to the Y electrode.

In the mode M1, the transistor Yr may be turned-on and the transistor Yg may be turned-off, such that a resonance may be generated through a path of the capacitor Cerc, the transistor Yr, the diode D1, the inductor Ly, and the panel capacitor Cp, thereby increasing a voltage of the Y electrode up to Vs.

In a mode M2, the transistor Ys may be turned-on and the transistor Yr may be turned off, such that the voltage Vs may be applied to the Y electrode.

In a mode M3, the transistor Yf may be turned-on and the transistor Ys may be turned-off, such that a resonance may be generated through a path of the panel capacitor Cp, the inductor L, the diode D2, the transistor Yf, and the capacitor Cerc, thereby decreasing the voltage of the Y electrode down to the low level voltage.

In the mode M4, the transistor Yg may be turned-on and the transistor Yf may be turned-off, such that 0V may again be applied to the Y electrode.

During the sustain period, the sustain driver 413 may supply a sustain discharge pulse alternately having the voltages Vs and 0V to the Y electrode by repeating modes M1 to M4 for a number of times corresponding to the weight of the subfield.

A sustain electrode driving circuit 510 may be connected to the X electrode. A sustain driver may apply 0V to the X electrode while the voltage Vs is applied to the Y electrode, and may apply the voltage Vs to the X electrode while 0V is applied to the Y electrode.

In the sustain electrode driving circuit 510, the sustain driver may have the same structure as the sustain driver 413 of the scan electrode driving circuit 410, and thus a detailed description thereof will not be repeated. In another implementation (not shown), the sustain driver of the sustain electrode driving circuit 510 may have a different structure from the sustain driver 413 of the scan electrode driving circuit 410.

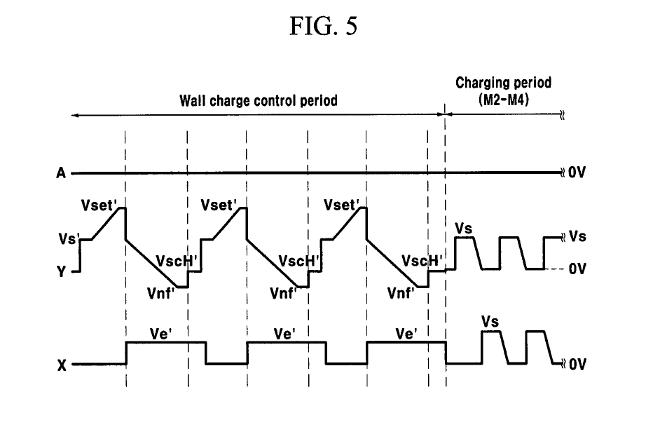

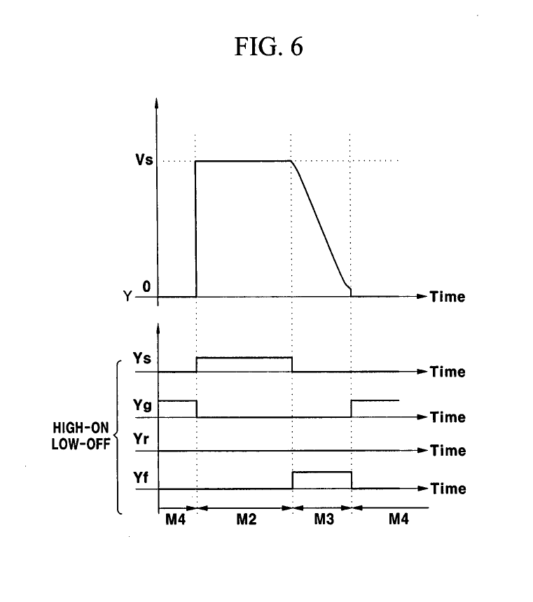

As described above, in order to increase the voltage of the Y electrode using the resonance during the mode M1 during the sustain period during normal display operation, a voltage may be charged at the capacitor Cerc. Before the normal display operation, charging of a predetermined voltage at the capacitor Cerc may be performed in accordance with an embodiment that will now be described in detail with reference to FIG. 5 and FIG. 6.

FIG. 5 illustrates a timing diagram of the sustain driver during an initial operation of the plasma display, in which a wall charge control period and a charging period are provided by the sustain driver 413, e.g., when power to the plasma display is first turned on. FIG. 6 illustrates details of a charging period in the signal timing diagram of FIG. 5.

Generally, when the plasma display is directly normally driven when the plasma display comes into a power-on state from a power-off state, the address discharge may not be properly performed during the address period, e.g., due to a lack of inter-cell priming particles and because a wall charge structure has not been previously controlled during a reset period. According to this embodiment, the initial operation waveforms shown in FIG. 5 may be applied to the X, Y, and A electrodes at an initial time, e.g., at the time the power to the plasma display is turned on, before the normal display operation starts.

As shown in FIG. 5, the initial operation waveforms may include a wall charge control period and a charging period. The wall charge control period may serve to control wall charges, such that uniform wall charges may be formed on each electrode after the power-on of the plasma display. The charging period may accumulate energy in the capacitor Cerc.

During the wall charge control period, waveforms may be applied to the X, Y, and A electrodes at least one time. These waveforms may be similar to the reset waveforms applied to the X, Y, and A electrodes during the reset period shown in FIG. 2. In an implementation, during the wall charge control period, the same waveform may be repeatedly applied, e.g., 3 times.

In detail, the voltage of the Y electrode may be gradually increased from the voltage Vs′ to the voltage Vset′ while the A and X electrodes are maintained at 0V. While the voltage of the Y electrode increases, a weak discharge may occur between the Y and X electrodes, and between the Y and A electrodes. Accordingly, negative (−) wall charges may be formed on the Y electrode, and positive (+) wall charges may be formed on the X and A electrodes. The voltage of the Y electrode may then be gradually decreased from the voltage Vs′ to the voltage Vnf′ while the X electrode is maintained at the voltage Ve′. While the voltage of the Y electrode decreases, a weak discharge may occur between the Y and X electrodes, and between the Y and A electrodes. Accordingly, negative (−) wall charges formed on the Y electrode, and positive (+) wall charges formed on the X and A electrodes, may be eliminated. When such a waveform is repeatedly applied, the state of the wall charges of all the discharge cells may become uniform. In an implementation, the voltages Vs′, Vset′, Vnf′, and VscH′ may be respectively equal to the voltages Vs, Vset, Vnf, and VscH.

Subsequently, during the charging period, a pulse alternately having the voltage Vs and 0V may be applied, in opposite phases, to the Y and X electrodes. That is, 0V may be applied to the X electrode while the voltage Vs is applied to the Y electrode, and the voltage Vs may be applied to the X electrode while 0V is applied to the Y electrode. At this time, the sustain driver 430 may repeat the modes M2 to M4, omitting mode M1 since voltage is not to be discharged from the capacitor Cerc to the Y electrodes. In mode M2, the voltage Vs may be applied to the Y electrode, and in mode M3, the energy stored in the Y electrode may be recovered into the capacitor Cerc and the voltage may be charged in the capacitor Cerc.

The operation of the sustain electrode driving circuit 510 may be the same as that described above, such that an initial charging operation may charge a storage capacitor in an energy recovery circuit in the sustain electrode driving circuit 510. Referring to FIG. 5, waveforms applied to the X electrodes may have a same shape and may be offset, e.g., by 180 degrees, from those applied to the Y electrodes during the charging period.

As described above, a sufficient voltage may be charged in the capacitor Cerc by an initial energy recovery circuit charging operation, which may be performed, e.g., upon initial start-up (power on) of the plasma display. Accordingly, during the subsequent normal driving operation, the voltage of the Y electrode may be increased by the inductor Ly during the initial part of the sustain period, and the voltage Vs may be applied to the Y electrode. Therefore, in a plasma display according to an example embodiment, energy may be sufficiently supplied to an energy recovery capacitor in an energy recovery circuit during an initial stage, e.g., upon power-on, and hard switching of the transistor for transmitting the voltage Vs, e.g., the transistor Ys, upon the normal operation may be prevented.

Example embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method of driving a plasma display that includes a plurality of first electrodes, a plurality of second electrodes, and a plurality of discharge cells corresponding to the first and second electrodes, the method comprising:
performing an initial energy recovery circuit charging operation; and
after performing the initial energy recovery circuit charging operation, performing a normal display operation, wherein:
the normal display operation charges a first capacitive structure in an energy recovery circuit of the plasma display and discharges the first capacitive structure to the plurality of first electrodes, and
the initial energy recovery circuit charging operation charges the first capacitive structure and does not discharge the first capacitive structure to the plurality of first electrodes.

2. The method as claimed in claim 1, wherein the initial energy recovery circuit charging operation includes, in sequence:
applying a first voltage to the plurality of first electrodes,
charging the first capacitive structure by connecting the plurality of first electrodes to a first capacitor via a first inductor, and
applying a second voltage to the plurality of first electrodes, the second voltage being less than the first voltage.

3. The method as claimed in claim 2, wherein the normal display operation includes, in sequence:
discharging the first capacitive structure to the plurality of first electrodes by connecting the plurality of first electrodes to the first capacitor via the first inductor,
applying the first voltage to the plurality of first electrodes,
charging the first capacitive structure by connecting the plurality of first electrodes to the first capacitor via the first inductor, and
applying the second voltage to the plurality of first electrodes.

4. The method as claimed in claim 2, wherein the initial energy recovery circuit charging operation further includes:
applying the first voltage to the plurality of second electrodes,
charging a second capacitive structure by connecting the plurality of second electrodes to a second capacitor via a second inductor, and
applying the second voltage to the plurality of second electrodes, wherein a waveform applied to the second electrodes has a same shape as a waveform applied to the plurality of first electrodes and is about 180 degrees offset from the waveform applied to the plurality of first electrodes.

5. The method as claimed in claim 2, wherein the initial energy recovery circuit charging operation includes two or more cycles of the sequence of applying the first voltage to the plurality of first electrodes, charging the first capacitive structure, and applying the second voltage to the plurality of first electrodes.

6. The method as claimed in claim 1, wherein the initial charging operation is performed upon power-on of the display.

7. The method as claimed in claim 6, wherein the initial charging operation is performed only upon power-on of the display.

8. The method as claimed in claim 1, further comprising performing a wall charge controlling operation before performing the initial energy recovery circuit charging operation, the wall charge controlling operation including applying a first waveform to the plurality of first electrodes and applying a fourth waveform to the plurality of second electrodes, such that a discharge occurs in the discharge cells.

9. The method as claimed in claim 8, wherein:
a second waveform is applied to the plurality of first electrodes during the initial energy recovery circuit charging operation,
a third waveform is applied to the plurality of second electrodes during the initial energy recovery circuit charging operation,
the third waveform has a same shape as the second waveform and is about 180 degrees offset from the second waveform, and
the third waveform and the fourth waveform have different shapes.

10. The method as claimed in claim 8, wherein applying the first waveform to the plurality of first electrodes during the wall charge controlling operation includes:
applying a gradually increasing voltage to the plurality of first electrodes while a third voltage is applied to the plurality of second electrodes, the gradually increasing voltage increasing increased from a fourth voltage to a fifth voltage, and
applying a gradually decreasing voltage to the plurality of first electrodes while a sixth voltage higher than the third voltage is applied to the plurality of second electrodes, the gradually decreasing voltage decreasing from a seventh voltage to an eighth voltage.

11. A plasma display, comprising:
a plurality of first electrodes;
a plurality of second electrodes;
a plurality of discharge cells corresponding to the first and second electrodes; and
a scan electrode driving circuit configured to initially charge a first energy recovery circuit of the plasma display and, after initially charging the first energy recovery circuit, to normally drive the display, wherein:
the scan electrode driving circuit is configured to charge a first capacitive structure in the first energy recovery circuit and discharge the first capacitive structure to the plurality of first electrodes during the normal driving of the display, and
the scan electrode driving circuit is configured to charge the first capacitive structure and to not discharge the first capacitive structure to the plurality of first electrodes during the initial charging of the first energy recovery circuit.

12. The plasma display as claimed in claim 10, wherein the scan electrode driving circuit is configured to sequentially apply a first voltage to the plurality of first electrodes, charge the first capacitive structure by connecting the plurality of first electrodes to a first capacitor via a first inductor, and apply a second voltage to the plurality of first electrodes, the second voltage being less than the first voltage, during the initial charging of the first energy recovery circuit.

13. The plasma display as claimed in claim 12, wherein the scan electrode driving circuit is configured to sequentially discharge the first capacitive structure to the plurality of first electrodes by connecting the plurality of first electrodes to the first capacitor via the first inductor, apply the first voltage to the plurality of first electrodes, charge the first capacitive structure by connecting the plurality of first electrodes to the first capacitor via the first inductor, and apply the second voltage to the plurality of first electrodes during the normal driving of the display.

14. The plasma display as claimed in claim 12, further comprising a sustain electrode driving circuit, wherein:
the sustain electrode driving circuit is configured to apply the first voltage to the plurality of second electrodes, charge a second capacitive structure in a second energy recovery circuit by connecting the plurality of second electrodes to a second capacitor via a second inductor, and apply the second voltage to the plurality of second electrodes during an initial charging of the second energy recovery circuit, and
a waveform applied to the plurality of second electrodes has a same shape as a waveform applied to the plurality of first electrodes and is about 180 degrees offset from the waveform applied to the plurality of first electrodes.

15. The plasma display as claimed in claim 12, wherein the scan electrode driving circuit is configured to apply the first voltage to the plurality of first electrodes, charge the first capacitive structure, and apply the second voltage to the plurality of first electrodes two or more times during the initial charging of the first energy recovery circuit.

16. The plasma display as claimed in claim 11, wherein the scan electrode driving circuit is configured to initially charge the first energy recovery circuit upon power-on of the display.

17. The plasma display as claimed in claim 16, wherein the scan electrode driving circuit is configured to initially charge the first energy recovery circuit only upon power-on of the display.

18. The plasma display as claimed in claim 11, wherein the scan electrode driving circuit is further configured to perform a wall charge controlling operation before the initial charging of the first energy recovery circuit, the wall charge controlling operation including applying a first waveform to the plurality of first electrodes and applying a fourth waveform to the plurality of second electrodes, such that a discharge occurs in the discharge cells.

19. The plasma display as claimed in claim 18, wherein:
the scan electrode driver is configured to apply a second waveform to the plurality of first electrodes during the initial charging of the first energy recovery circuit,
a sustain electrode driver is configured to apply a third waveform to the plurality of second electrodes during an initial charging of a second energy recovery circuit,
the sustain electrode driver is configured to apply the fourth waveform to the plurality of second electrodes,
the third waveform has a same shape as the second waveform and is about 180 degrees offset from the second waveform, and
the third waveform and the fourth waveform have different shapes.

20. The plasma display as claimed in claim 18, wherein applying the first waveform to the plurality of first electrodes during the wall charge controlling operation includes:
applying a gradually increasing voltage to the plurality of first electrodes while a third voltage is applied to the plurality of second electrodes, the gradually increasing voltage increasing increased from a fourth voltage to a fifth voltage, and
applying a gradually decreasing voltage to the plurality of first electrodes while a sixth voltage higher than the third voltage is applied to the plurality of second electrodes, the gradually decreasing voltage decreasing from a seventh voltage to an eighth voltage.
